(19) United States
(12) Patent Application Publication
(10) Pub. No.: US 2026/0285499 A1
(43) Pub. Date: Sep. 24, 2026

(54) MONITORING OF AN AIRCRAFT PROPULSION SYSTEM

(71) Applicant: SAFRAN HELICOPTER ENGINES, BORDES (FR)

(72) Inventors: David Bernard Martin LEMAY, MOISSY-CRAMAYEL (FR); Jean-Philippe Jacques MARIN, MOISSY-CRAMAYEL (FR); Romain Jean Gilbert THIRIET, MOISSY-CRAMAYEL (FR)

(73) Assignee: SAFRAN HELICOPTER ENGINES, BORDES (FR)

(21) Appl. No.: 18/998,033

(22) PCT Filed: Jul. 27, 2023
(86) PCT No.: PCT/FR2023/051196

§ 371 Date: Jan. 23, 2025

(30) Foreign Application Priority Data
Jul. 29, 2022 (FR) 2207908

(51) Int. Cl. B64D 45/00; B64D 27/10; G01M 15/14; G06F 11/07

(52) U.S. Cl. CPC B64D 45/00; B64D 27/10; G01M 15/14; G06F 11/0739; G06F 11/076; B64D 2045/0085

(57) ABSTRACT

The invention relates to a method for monitoring a propulsion system (102) of an aircraft (100), which comprises:—calculating, for each damage counter (FC, EF), a maximum incrementation rate (dC_FC_max, dC_EF_max) of the counter (FC, EF) so that the counter (FC, EF) remains below a predefined threshold (C_FC_max, C_EF_max) throughout a target service life (DDV_cible);—calculating, on the basis of one or more thresholds (NGmax FC, NGmax EF, T4xmax_EF) of at least one parameter (NG, T4x), at least one limit (PEinf, PEsup) of an operating variable of the turboshaft engine (TM) which must not be exceeded so that the incrementation rate (dC_FC, dC_EF) of the counter (FC, EF) remains below the maximum incrementation rate (dC_FC_max, dC_EF_max); and—transmitting a current value and the limit (PEinf, PEsup) of the operating variable to a display device (AF) of the aircraft (100).

### TECHNICAL FIELD OF THE INVENTION

The invention relates to the aircraft propulsion systems, and more specifically to the service life of a turboshaft engine.

### TECHNICAL BACKGROUND

A propulsion system typically comprises a turboshaft engine to drive a rotating propulsion unit of the aircraft, for example to drive the main rotor and the anti-torque rotor in the case of a helicopter.

The turboshaft engine has a service life (or conversely, a rate of damage) that depends on its power demands. This service life depends mainly on the speed of rotation of the rotating assemblies (for example, the speed NG of the gas generator, the speed N2 of a free turbine of the turboshaft engine TM, and the temperature T4x of the gas driving one or more power turbines of the turboshaft engine TM.

Two damage modes are generally taken into account: the cyclic fatigue and the creep. The aircraft thus comprises a cyclic fatigue counter and a creep counter. When one of the counters reaches a predefined threshold, a maintenance of the turboshaft engine must be performed.

The aim of the invention is to allow pilots to manage their flight to achieve a desired service life.

### SUMMARY OF THE INVENTION

It is proposed a method for monitoring a propulsion system of an aircraft, the propulsion system comprising a turboshaft engine and the aircraft comprising at least one counter for a damage to the turboshaft engine using at least one parameter of the turboshaft engine, the method being characterized in that it comprises:
receiving a target service life;
calculating, for each counter, a maximum incrementation rate of the counter so that the counter remains below a predefined threshold throughout the target service life;
calculating, for each counter and for each parameter of this counter, a threshold such that, as long as the parameter does not exceed the threshold, the incrementation rate of the counter remains lower than the maximum incrementation rate;
calculating, on the basis of the threshold or thresholds, at least one limit of an operating variable of the turboshaft engine which must not be exceeded so that the incrementation rate of the counter remains lower than the maximum incrementation rate; and
transmitting to a display device on the aircraft a current value and the limit of the operating variable.

The invention may also comprise one or more of the following optional characteristics, in any technically possible combination.

Optionally, a lower limit and an upper limit of the operating variable of the turboshaft engine are calculated.

Also optionally, the aircraft also comprises a cyclic fatigue counter using a speed of rotation of a part of the turboshaft engine and/or a creep counter using a speed of rotation of a part of the turboshaft engine and a temperature of gas at the level of a turbine of the turboshaft engine.

Also optionally, the maximum incrementation rate is calculated by: dC_XX_max=C_XX max/DDV_target, where dC_XX_max is the maximum incrementation rate, C_XX_max is the predefined threshold of the counter and DDV_target is the target service life.

Also optionally, the maximum incrementation rate is also calculated by: dC_XX_max =(C_XX_max−C_XX_current)/DDV_target−DDV_elapsed), where dC_XX_max is the maximum incrementation rate, C_XX_max is the predefined threshold of the counter, C_XX current is the current value of the counter, DDV_target is the target service life and DDV_elapsed is the service life that has already elapsed.

Also optionally, each counter implements a damage law giving the incrementation rate from the parameter or parameters used by that counter and wherein the threshold of each parameter used by that counter is calculated by applying the inverse damage law to the maximum incrementation rate.

Also proposed is a computer program which may be downloaded from a communications network and/or recorded on a computer-readable medium, characterized in that it comprises instructions for executing the steps of a method according to the invention, when said program is executed on a computer.

It is also proposed an aircraft comprising:
a propulsion system for an aircraft, the propulsion system comprising a turboshaft engine;
at least one counter of a damage to the turboshaft engine using at least one parameter of the turboshaft engine;
a display device; and
a computer designed to implement a method according to the invention.

### BRIEF DESCRIPTION OF THE FIGURES

The invention will be better understood with the aid of the following description, given only by way of example and made with reference to the attached drawings wherein:

FIG. 1 is a functional view of an aircraft wherein the invention is implemented,

FIG. 2 is a block diagram of a method for monitoring a propulsion system of the aircraft shown in FIG. 1, and

FIG. 3 is a view of a first limit indicator for the aircraft in FIG. 1.

### DETAILED DESCRIPTION OF THE INVENTION

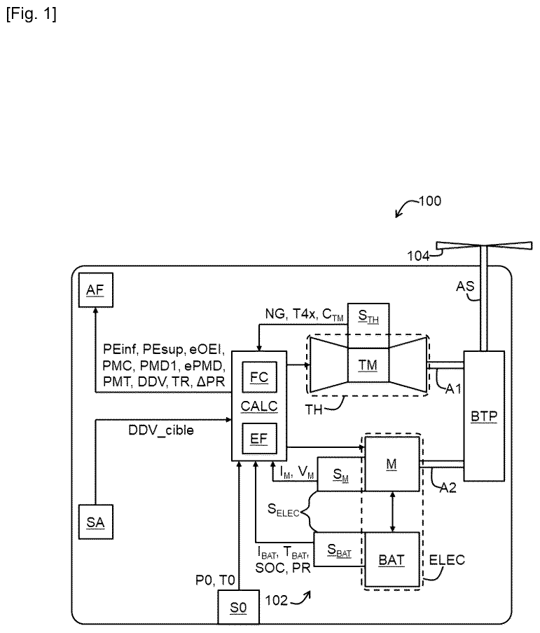

With reference to FIG. 1, an example of an aircraft 100 wherein the invention is implemented will now be described.

The aircraft 100 may be a fixed-wing or rotary-wing aircraft (as in the case of a helicopter), or a Vertical Take-Off & Landing aircrafts (VTOL).

The aircraft thus comprises a propulsion system 102.

The propulsion system 102 comprises at least one rotating propulsion unit 104. In the case of a helicopter, the propulsion system 102 comprises, for example, two rotating propulsion units: a main rotor designed to provide the lift, the control and the propulsion, and an anti-torque rotor designed to counter a torque induced by the main rotor. Alternatively, the rotating propulsion unit 104 may be a propeller or a fan.

The propulsion system 102 also comprises a thermal chain TH for driving each rotating propulsion unit 104. In the example shown, the TH thermal chain comprises a single turboshaft engine TM. Alternatively, the thermal chain TH could comprise several turboshaft engines.

Particularly in the case of a helicopter, the propulsion system 102 also comprises, for example, a main gearbox BTP comprising an input shaft A1 connected to the thermal chain TH and an output shaft AS connected to the rotating propulsion unit 104.

The propulsion system 102 also comprises an electrical chain ELEC for driving each rotating propulsion unit 104. The electrical chain ELEC comprises, for example, an electrical storage source BAT and an electrical machine M connected to the electrical storage source BAT. The electrical storage source BAT may comprise one or more elementary electrical sources, for example one or more chemical batteries or any other type of electrical energy storage device. Similarly, the electrical machine M may comprise one or more elementary electrical machines. The electrical machine M is designed to operate selectively, on the one hand, as a motor to receive electrical power from the electrical storage source BAT and, on the other hand, as a generator to supply electrical power to the electrical storage source BAT to recharge the latter. Alternatively, the electrical machine M may be designed to operate solely as a motor.

Due to the presence of the thermal chain TH and the electrical chain ELEC, the propulsion system 102 is thus described as hybrid.

In the case of so-called parallel hybridization as illustrated, the main gearbox BTP comprises a second input shaft A2 connected to the electrical chain ELEC, in particular to the electrical machine M.

The aircraft 100 also comprises a computer CALC for controlling the propulsion system 102, more specifically the thermal chain TH and the electrical chain ELEC.

The propulsion system 102 has at least one certified operating mode. This means that the engine manufacturer guarantees, for each regime, that each of the thermal chain TH and the electrical chain ELEC is capable of supplying a maximum power (called limit) associated with that regime, possibly for a predefined duration associated with that regime. This duration is finite and may be zero. In the absence of an associated duration, the manufacturer guarantees that the maximum power may be reached for as long as required, and in any case for a very long duration, for example the typical duration of a mission.

The maximum power and the durations may be different for the thermal chain TH and for the electrical chain ELEC. So, in general, each mode defines, on the one hand, for the thermal chain TH, a maximum power and possibly a duration, and, on the other hand, for the electrical chain ELEC, a maximum power and possibly a duration.

Each limit may be “controlled”, i.e. indicative. It is then up to the pilot to comply with this limit according to the information in the user manual for the propulsion system 102. If the pilot requests more power than the piloted limit, the computer CALC is designed to allow the propulsion system 102 to exceed the piloted limit.

Each limit may alternatively be “controlled”, i.e. the computer CALC is designed to prevent them from being crossed, even if the pilot requests it to do so. The controlled limits are sometimes referred to as “stops”.

For example, the propulsion system 102 may have one or more of the following regimes.

The propulsion system 102 may have a continuous regime C, associated with a controlled limit PMC (Maximum Continuous Power) which is the maximum power that the thermal chain TH is capable of delivering continuously, i.e. over the entire duration of a mission, or even several missions of the aircraft 100.

The propulsion system 102 may have a maximum take-off regime D, associated with a piloted limit PMD_{TH} (PMD for Maximum Take-off Power) which is the power that the thermal chain TH may deliver for a predefined duration T_PMD_{TH} and with a piloted limit PMD_{ELEC} which is the power that the electrical chain ELEC may deliver for a predefined duration T_PMD_{ELEC}. The durations T_PMD_{TH} and T_PMD_{ELEC} are generally of the order of a few minutes (commonly of the order of fifteen to thirty minutes).

The propulsion system 102 may have a maximum transient regime T, associated with a controlled limit PMT_{TH} (PMT for Maximum Transient Power) which is the maximum instantaneous power that the thermal chain TH may deliver and a controlled limit PMT_{ELEC} which is the maximum instantaneous power that the electrical chain ELEC may deliver. For the maximum transient regime T, the duration for the thermal chain TH and the duration for the electrical chain are both zero.

To calculate the different information to be displayed to the pilot, as will be explained in more detail later, the aircraft 100 comprises several measurement systems.

More specifically, the aircraft 100 firstly comprises a system S_{TH} for monitoring the thermal chain TH, designed to measure at least one parameter of the thermal chain TH having an impact on the power supplied by the thermal chain TH. For example, a speed NG of a gas generator of the turboshaft engine TM and/or a temperature T4x of the gas driving one or more power turbines of the turboshaft engine TM and/or a torque C_{TM} supplied by the turboshaft engine or engines of the thermal chain TH.

The aircraft 100 also comprises a system S_{ELEC} for monitoring the electrical chain ELEC, designed to measure at least one parameter of the electrical chain ELEC having an impact on the power supplied by the electrical chain ELEC.

The parameters having an impact on the power supplied by the thermal chain TH and the power supplied by the electrical chain ELEC are referred to below as the main parameters.

The measurement system S_{ELEC} comprises, for example, a system S_{BAT} for measuring at least one parameter of the electrical storage source BAT, such as a current I_{BAT} supplied by the electrical storage source BAT to the electrical machine M and/or a state of charge SOC of the electrical storage source BAT. The measurement system S_{ELEC} comprises, for example, instead of or in addition to the measurement system S_{BAT}, a system S_{M} for measuring at least one parameter of the electrical machine M, such as a torque C_{M} supplied by the electrical machine M. The measurement system S_{ELEC} is also designed, for example, to measure at least one other so-called auxiliary parameter of the electrical chain ELEC, such as a temperature T_{BAT} of the electrical storage source BAT measured by the measurement system S_{BAT} and/or a recharging power PR of the electrical storage source BAT. The recharging power PR is calculated, for example, from the current I_{BAT} of the electrical storage source BAT and a voltage measured at the terminals of the electrical storage source BAT.

The aircraft 100 also comprises, for example, an external monitoring system S0, designed to measure at least one atmospheric parameter around the aircraft 100, such as an atmospheric pressure P0 and/or an atmospheric temperature T0.

The aircraft 100 also comprises a display device AF designed to display the information transmitted by the computer CALC.

The aircraft 100 may also comprise an input device SA designed to allow the pilot to enter information for the computer CALC, in particular a target service life DDV_target. The input device SA may take a number of forms, such as an adjustment knob (potentiometer type) on an aircraft instrument panel, an input keyboard on a screen, and so on.

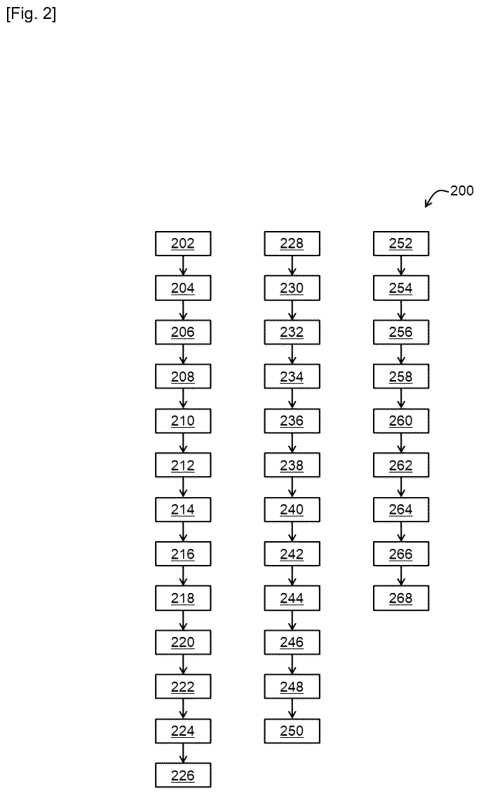

With reference to FIG. 2, an example of a method 200 according to the invention, for monitoring the propulsion system 102, will now be described.

During a step 202, the computer CALC receives a measurement of each parameter.

In the example shown, the computer CALC receives:
measurements NG_m, T4x_m, C_{TM_m} of the main parameters NG, T4x, C_{TM} of the thermal chain TH,
measurements I_{BAT_m}, C_{M_m} of the main parameters I_{BAT}, C_{M} of the electrical chain ELEC,
measurements T_{BAT_m}, SOC_m of the auxiliary parameters T_{BAT}, SOC of the electrical chain ELEC, and
measurements P0_m, T0_m of the atmospheric parameters P0, T0.

During a step 204, the computer CALC calculates, for each regime and for each main parameter of the thermal chain TH, a threshold below which the main parameter in question must remain in order for the thermal chain TH to supply a power lower than the maximum power of the regime in question for the thermal chain TH. This calculation is based, for example, on one or more other measured parameters, such as the atmospheric parameter or parameters.

In the example shown, the computer CALC calculates, for example, from the measurements P0_m, T0_m:
for the continuous regime C, the thresholds NG_C, T4x_C and C_{TM}_C,
for the take-off regime D, the thresholds NG_D, T4x_D and C_{TM_D}, and
for the transient regime T, the thresholds NG_T, T4x_T and C_{TM}_T.

During a step 206, the computer CALC calculates, for each regime and for each main parameter of the thermal source TH, a difference between the measurement and the threshold of the main parameter in question, this difference forming a margin of the main parameter in question.

In the example shown, the computer CALC calculates:
for the continuous regime C, the margins ΔNG_C, ΔT4x_C and ΔC_{TM}_C,
for the take-off regime D, the margins ΔNG_D, ΔT4x_D and ΔC_{TM}_D, and
for the transient regime T, the margins ΔNG_T, ΔT4x_T and ΔC_{TM}_T.

In a step 208, the computer CALC calculates, for each regime with a finite duration, possibly zero, and for each main parameter of the electrical chain ELEC, a threshold below which the main parameter in question must remain in order for the electrical chain ELEC to supply a power lower than the maximum power of the regime in question for the electrical chain ELEC. This calculation is based, for example, on one or more other measured parameters, such as the atmospheric parameter or parameters.

In the example shown, the computer CALC calculates, for example from the measurements SOC_m, T_{BAT_m}, P0_m and T0_m:
for the take-off regime D, the thresholds I_{BAT}_D and C_{M}_D, and
for the transient regime T, the thresholds I_{BAT}_T and C_{M}_T.

Thus, no threshold is calculated for the continuous regime C for the electrical chain ELEC.

During a step 210, the computer CALC calculates, for each regime with a finite duration, possibly zero, and for each main parameter of the electrical chain ELEC, a difference between the measurement and the threshold of the main parameter in question, this difference forming an intermediate margin of the main parameter in question.

In the example shown, the computer CALC calculates:
for take-off regime D, the intermediate margins ΔI_{BAT}_D′ and ΔC_{M}_D′, and
for the transient regime T, the intermediate margins ΔI_{BAT}_T′ and ΔC_{M}_T.

In step 212, the computer CALC converts the margins calculated in steps 206 and 210 into the same unit, which may be that of any physical quantity. Preferably, this physical quantity is “meaningful” to the pilot and directly linked to his piloting. The unit chosen is power, for example, so the margins are converted into power margins. Converted in this way, the margins may be compared and/or summed. Power is, for example, the mechanical power supplied.

For example, the current margin I_{BAT} may be expressed as power by multiplying it by a voltage of the electrical storage source BAT and by an efficiency of the electrical machine M.

Also for example, the torque margin C_{M} may be expressed as power by multiplying it by the speed of rotation of the electric machine M.

The parameters of the thermal chain TH, for example, may be converted into power using a model of the turboshaft engine TM and assuming all the other parameters of this engine to be constant.

In addition, during step 212, the thresholds of the main parameters of the electrical chain ELEC (the thresholds of the parameters I_{BAT} and C_{M} in the example shown) are also converted into the chosen unit, for example into power.

During a step 214, for each regime with a non-zero finite duration associated with the electrical chain ELEC, the computer CALC checks whether the electrical storage source BAT is sufficiently charged for the electrical chain ELEC to be able to supply the power threshold of this parameter, throughout the associated duration. In particular, to evaluate the charge of the electrical storage source BAT, it is possible to use, for example, the measurement SOC_m of the state of charge SOC of the electrical storage source BAT. Alternatively, a State Of Energy (SOE) measurement could be used.

For example, for the take-off regime D and for the current I_{BAT}, the computer CALC checks whether: SOC≥I_{BAT}_D×T_PMD_{ELEC}, I_{BAT}_D being expressed in power and T_PMD_{ELEC} being the maximum duration of the take-off regime D for the electrical chain.

If the electrical storage source BAT is sufficiently loaded, then the margin of the main parameter in question is taken to be equal to its intermediate margin. In this case, for example, the margin ΔI_{BAT}_D of the parameter I_{BAT} is taken to be equal to the intermediate margin ΔI_{BAT}_D′.

Otherwise, the margin of the main parameter in question is taken to be less than the intermediate margin.

In a first example, the parameter margin is taken to be zero. In this case, for example, if SOC<I_{BAT}_D×T_PMD_{ELEC}, the margin ΔI_{BAT}_D of the parameter I_{BAT} is taken to be zero.

In a second example, if the electrical storage source BAT is not sufficiently charged, the parameter margin is taken to be equal to the state of charge SOC divided by the duration associated with the regime for the electrical chain ELEC. In this case, for example, if SOC <I_{BAT}_D×T_PMD_{ELEC}, the margin ΔI_{BAT}_D of the parameter I_{BAT} is taken to be equal to SOC/T_PMD_{ELEC}.

During a step 216, for each regime with an associated zero duration, the margin of the main parameter in question is then taken to be equal to its intermediate margin. In this case, for example, the margin ΔI_{BAT_}T of the parameter I_{BAT} is taken to be equal to the intermediate margin ΔI_{BAT}_T′.

During a step 218, when several parameters of the thermal chain TH are used, the computer CALC compares, for each regime, the margins of these parameters to select the smallest. The selected margin is taken as the margin of the thermal chain TH.

For example, the margin of the thermal chain TH is noted PMC for the continuous regime C, PMD1 for the take-off regime D and PMT1 for the transient regime T.

During a step 220, when several parameters of the electrical chain ELEC are used, the computer CALC compares, for each regime, the margins of these parameters in order to select the smallest.

For example, the margin of the electrical chain ELEC is noted ΔP_{ELEC}_PMD for the take-off regime D and ΔP_{ELEC}_PMT for the transient regime T.

During a step 222, the computer CALC adds, for each regime, the smallest margin for the thermal chain TH with the smallest margin for the electrical chain ELEC, this addition forming a total margin for the propulsion system 102 for the regime in question.

For example, the total margin is ePMD for the take-off regime D and is equal to: ePMD=PMD1+ΔP_{ELEC}_PMD. In a similar way, the total margin is noted ePMT for the transient regime T and is equal to: ePMT=PMT1+ΔP_{ELEC}_PMT.

During a step 224, the computer CALC transmits the total margin associated with each regime to the display device AF. In addition, the computer CALC may transmit, for each regime, the margin for the thermal chain TH alone (without the electrical chain ELEC).

In the example shown, the computer CALC transmits the margin ePMD and the margin PMD1 for the take-off regime D and the margin ePMT for the transient regime T. For the continuous regime C, the computer CALC transmits the margin PMC.

In a step 226, the display device AF displays the margins received. It also displays the total power supplied by the propulsion system 102.

Furthermore, during flight, the computer CALC is designed so that the power supplied by the propulsion system 102 is allocated as a priority to the needs of the aircraft ahead of recharging the electrical storage source BAT (e.g. the power required by the main and anti-torque rotors to carry out the maneuver commanded by the pilot). When the power supplied by the thermal chain TH falls, recharging of the electrical storage source BAT is reduced to ensure that power is available to the pilot. This operation may be carried out automatically so that the pilot only has to worry about the flight. In this case, however, it may be useful to provide the pilot with summary information to help him manage the recharging of the electrical storage source BAT when the flight conditions allow (e.g. in cruise flight or during descent on the approach to landing).

To do this, during a step 228, the computer CALC calculates a maximum recharge power for the electrical storage source BAT, for example from measured parameters such as the state of charge SOC of the electrical storage source BAT, the temperature T_{BAT} of the electrical storage source BAT and the atmospheric temperature T0. This maximum recharge power is calculated, for example, by a mathematical function or a table of values depending on the relevant parameters and stored in a memory accessible by the computer CALC. This limit may be expressed as a power (in Watts), an electric current or any other quantity or unit of measurement chosen by the designer.

In a step 230, the computer CALC receives a measurement of a recharge power PR from the electrical storage source BAT.

In a step 232, the computer CALC calculates a difference between the recharge power measurement PR and the maximum recharge power, this difference forming an instantaneous recharge power margin ΔPR.

In a step 234, the computer CALC transmits the instantaneous recharge power margin ΔPR to the display device AF.

In a step 236, the display device AF displays the instantaneous recharge power margin ΔPR to the pilot.

In a step 238, the computer CALC calculates a difference between a target state of charge SOC* and a measure SOC_m of the state of charge SOC, this difference forming an energy remaining to be recharged. The state of charge SOC may be measured using measurements of parameters of the electrical storage source BAT (for example, the voltage at its terminals and the current I_{BAT}) and a mathematical model of the latter.

In a step 240, the computer CALC calculates a maximum recharge power profile for the electrical storage source BAT up to the target state of charge SOC*. This profile may be calculated using measurements of parameters of the electrical storage source BAT (for example, the voltage at its terminals and the current I_{BAT}) and a mathematical model of the latter.

In a step 242, the computer CALC receives a measurement of the recharge power PR from the electrical storage source BAT.

During a step 244, the computer CALC calculates a recharge power profile by selecting for each point the minimum between the maximum recharge power profile and the current power.

In a step 246, the computer CALC calculates a remaining recharge time TR as the integral of the ratio between the energy remaining to be charged and the recharge power profile. In practice, this integral may be calculated by the control system as the sum of the intervals of the discretized power trajectory.

In a step 248, the computer CALC transmits the remaining recharge time TR to the display device AF.

In a step 250, the display device AF shows the remaining recharge time TR.

In addition, the turboshaft engine TM has a service life (or conversely, a rate of damage) that depends on its power demands. This service life depends mainly on the rotational speed of the rotating assemblies (for example, the speed NG of the gas generator, free turbine: NTL/N2), and the T4x temperature.

Two damage modes are generally taken into account: the cyclic fatigue and the creep.

The computer CALC comprises a cyclic fatigue counter FC and a creep counter EF.

The cyclic fatigue is induced by the mechanical stress caused by the centrifugal acceleration undergone by rotating assemblies (compressor or compressors, HP turbine or turbines, LP turbine or turbines).

The cyclic fatigue counter FC is designed to count cycles of variation of speed NG over time. These cycles generally comprise, for each mission (i.e. the period during which the aircraft is switched on), a main cycle between start-up (zero speed NG) and the maximum mission speed, as well as partial cycles during the mission.

For example, the cyclic fatigue counter FC is designed to calculate, at each time step, an increment dC_FC from a measurement NG_m of the speed NG at that time step and from a history of measurements of the speed NG, by implementing a predefined damage law f1: dC_FC=f1(NG_m, previous measurements).

The creep characterizes the expansion of the turbine blades on the turboshaft engine TM. The creep is caused by the combined effect of centrifugal acceleration and the high temperature to which rotating parts are subjected. It therefore depends on the power the pilot requires from the engine and the atmospheric conditions P0, T0.

The creep counter EF is designed to calculate, at each time step, an increment dC_EF from a measurement NG_m of the speed NG and a measurement T4x_m of the temperature T4x at that time step, implementing a predefined damage law f2: dC_EF=f2(NG_m, T4x_m).

When one of the counters FC, EF reaches a predefined threshold (noted C_FC_max for the cyclic fatigue counter FC and C_EF_max for the creep counter EF), maintenance of the turboshaft engine TM must be performed.

To allow the pilot to manage his flight to achieve a desired service life, the following steps may be implemented.

In a step 252, the input device SA receives the target service life DDV_target from the propulsion system 102, and transmits it to the computer CALC. The target service life DDV_target is entered by the pilot, for example, and may be adjusted before each flight, depending on a compromise between the aircraft's operating cost and the service provided on the mission (on-board load and flight duration).

During a step 254, the computer CALC receives the target service life DDV_target.

In a step 256, the computer CALC calculates, for each counter FC, EF, a maximum incrementation rate of the counter FC, EF that remains below a predefined threshold throughout the target service life DDV_target.

In a first example, the maximum incrementation rate is calculated assuming linear wear over the entire target service life DDV_target. Thus, the maximum incrementation rate dC_FC_max of the cyclic fatigue counter FC is given by: dC_FC_max=C_FC_max/DDV_target and the maximum incrementation rate dC_EF_max of the creep counter EF is given by: dC_EF_max=C_EF_max/DDV_target. The maximum incrementation rates are therefore constant as long as the target service life DDV_target is not modified.

In a second example, each maximum incrementation rate is calculated “dynamically”, based on the past use of the turboshaft engine TM. In this way, each maximum incrementation rate is calculated by considering linear wear from the current situation, current counter value FC, EF and elapsed part DDV_elapsed of the target service life DDV_target. The maximum incrementation rate dC_FC_max of the cyclic fatigue counter FC is given by: dC_FC_max=(C_FC_max−C_FC_current)/DDV_target−DDV_elapsed) and the maximum incrementation rate dC_EF_max of the creep counter EF is given by: dC_EF_max=(C_EF_max−C_EF_current)/DDV_target−DDV_elapsed). It will be appreciated that DDV_target−DDV_elapsed equals the remaining service life, noted DDV.

In this way, if the turboshaft engine is regularly used at high power levels at the start of the mission (for example: use at a power level close to power PMD on take-off and during climb), the maximum incrementation rate is adapted downwards to encourage the pilot to use the turboshaft engine TM less for the rest of the flight.

In a step 258, the computer CALC calculates a threshold NGmax_FC for the speed NG from the function f1 of the cyclic fatigue counter FC and the maximum incrementation rate of the cyclic fatigue counter FC. More specifically, the threshold NGmax_FC is calculated by applying the inverse damage law f1⁻¹ to the maximum incrementation rate dC_FC_max, with knowledge of the measurement history: NGmax_FC=f1⁻¹(dC_FC_max).

During a step 260, the computer CALC calculates a threshold NGmax_EF for the speed NG and a threshold T4xmax_EF for the temperature T4xmax, from the function f2 of the creep counter EF and the maximum incrementation rate of the creep counter EF. More specifically, the threshold NGmax_EF and the threshold T4xmax_EF are calculated by applying the inverse damage law f2⁻¹ to the maximum incrementation rate dC_FC_max: (NGmax_EF, T4xmax_EF)=f2⁻¹(dC_EF_max). It will be appreciated that, as the speed NG and the temperature T4x are linked to each other by the operation of the turboshaft engine TM, the inverse damage law f2⁻¹ gives only one possible combination of NGmax_EF, T4xmax_EF.

During a step 262, the computer CALC calculates, on the basis of the thresholds NGmax_FC, NGmax_EF, T4xmax_EF and with the aid of a model of the turboshaft engine TM, an upper limit PEsup of an operating variable of the turboshaft engine TM, for example a power supplied by the turboshaft engine TM.

For example, the computer CALC calculates, as the upper limit PEsup, the mechanical power that the turboshaft engine TM may deliver without exceeding these thresholds NGmax_FC, NGmax_EF, T4xmax_EF, using a model of the turboshaft engine TM.

In a step 264, the computer CALC calculates a lower limit PEinf using the damage law in partial cycles.

For example, the computer CALC calculates, as the lower limit PEinf, the mechanical power that the turboshaft engine TM may deliver without falling below this threshold NGmin_FC, T4xmax_EF (apart from a shutdown of the turboshaft engine TM), using a model of the turboshaft engine TM.

In a step 266, the computer CALC transmits to the display device AF a current value of the mechanical power supplied by the propulsion system 102, the lower limit PEinf and the upper limit PEsup.

In a step 268, the display device AF displays the current value of the mechanical power supplied, the lower limit PEinf and the upper limit PEsup.

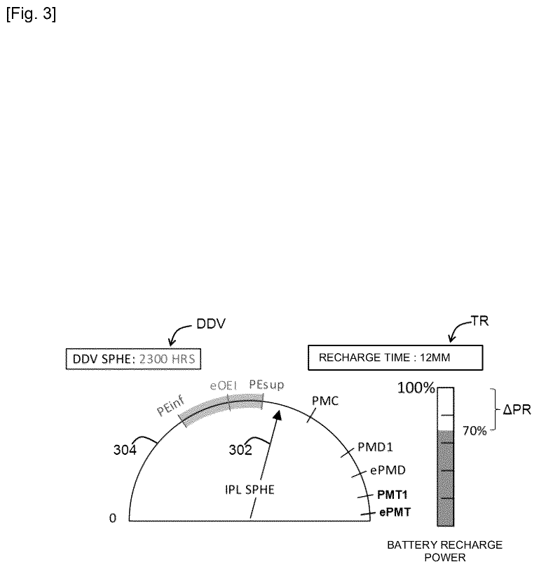

With reference to FIG. 3, an example of display by the display device AF is illustrated.

In this example, the power supplied by the system is indicated by a rotating needle 302.

The margins PMC, PMD1, ePMD, PMT1, ePMT are indicated as markers along a stroke 304 of the rotating needle 302, as are the lower limit PEinf and the upper limit PEsup.

It will be further noted that the invention is not limited to the embodiments described above. In fact, it will appear to the person skilled in the art that various modifications may be made to the above-described embodiments, in the light of the teaching just disclosed.

In the foregoing detailed presentation of the invention, the terms used should not be interpreted as limiting the invention to the embodiments exposed in the present description, but should be interpreted to include all equivalents the anticipation of which is within the reach of the person skilled in the art by applying his general knowledge to the implementation of the teaching just disclosed.

1. A method for monitoring a propulsion system of an aircraft, the propulsion system having a turboshaft engine and the aircraft having at least one counter for a damage to the turboshaft engine using at least one parameter of the turboshaft engine, the method comprising:
receiving a target service life;
calculating, for each counter, a maximum incrementation rate of the counter so that the counter remains below a predefined threshold throughout the target service life;
calculating, for each counter and for each parameter of the counter, a threshold such that, so long as the parameter does not exceed the threshold, the incrementation rate of the counter remains lower than the maximum incrementation rate;
calculating, on the basis of the threshold or thresholds, at least one limit of an operating variable of the turboshaft engine to not be exceeded so that the incrementation rate of the counter remains lower than the maximum incrementation rate; and
transmitting to a display device on the aircraft a current value of the operating variable and the limit of the operating variable.

2. The method according to claim 1, wherein the at least one limit includes a lower limit (PEinf) and an upper limit (PEsup) of the operating variable.

3. The method according to claim 1, wherein the aircraft comprises a cyclic fatigue counter using a speed of rotation of a part of the turboshaft engine and/or a creep counter using a speed of rotation of a part of the turboshaft engine and a temperature of gas at the level of a turbine of the turboshaft engine.

4. The method according to claim 1, wherein the maximum incrementation rate is calculated by: dC_XX_max=C_XX_max/DDV_target, where dC_XX_max is the maximum incrementation rate, C_XX_max is the predefined threshold of the counter, and DDV_target is the target service life.

5. The method according to claim 1, wherein the maximum incrementation rate is calculated by: dC_XX_max=(C_XX_max−C_XX_current)/(DDV_target−DDV_elapsed), where dC_XX_max is the maximum incrementation rate, C_XX_max is the predefined threshold of the counter, C_XX_current is the current value of the counter, DDV_target is the target service life, and DDV_elapsed is the service life already elapsed.

6. The method according to claim 1, wherein each counter implements a damage law giving the incrementation rate from the parameter or parameters used by this counter, and wherein the threshold of each parameter used by that counter is calculated by applying the inverse damage law to the maximum incrementation rate.

7. A computer program which may be downloaded from a communications network and/or recorded on a computer-readable medium, the computer program comprising instructions for executing the steps of a method according to claim 1, wherein the program is executed on a computer.

8. An aircraft, comprising:
a propulsion system for an aircraft, the propulsion system comprising a turboshaft engine;
at least one counter of a damage to the turboshaft engine using at least one parameter of the turboshaft engine;
a display device; and
a computer configured to implement a method according to claim 1.
